(19) United States
(12) Patent Application Publication
(10) Pub. No.: US 2022/0329291 A1
(43) Pub. Date: Oct. 13, 2022

(54) BEAM ALIGNMENT FOR MILLIMETER WAVE SYSTEMS IN PRESENCE OF MULTI-PATH

(71) Applicant: NEC Laboratories America, Inc., Princeton, NJ (US)

(72) Inventor: Mohammad Khojastepour, Lawrenceville, NJ (US)

(21) Appl. No.: 17/714,388

(22) Filed: Apr. 6, 2022

Related U.S. Application Data
(60) Provisional application No. 63/172,145, filed on Apr. 8, 2021.

(51) Int. Cl. H04B 7/0408; H04B 7/08; H04B 7/0426

(52) U.S. Cl. CPC H04B 7/0408; H04B 7/0817; H04B 7/043

(57) ABSTRACT

A method for implementing a multi-user beam alignment (BA) scheme in a multi-path environment of a single-cell millimeter wave network is presented. The method includes enabling a base station to communicate with a plurality mobile devices handled by a plurality of users within the single-cell mmWave network, estimating an angle of departure for the plurality of users within a discrete set of intervals, transmitting, via the base station, scanning beams (SBs) to receive feedback messages from the plurality of users, the feedback messages determining if an AoD associated with a resolvable path of the user belongs to an angular coverage region of a given beam, transmitting, via the base station, data transmission beams (DTBs) as a function of the feedback messages and the SBs, and applying a spatial diversity policy and a beamforming policy based on the feedback messages.

### RELATED APPLICATION INFORMATION

This application claims priority to Provisional Application No. 63/172,145, filed on Apr. 8, 2021, the contents of which are incorporated herein by reference in their entirety.

### BACKGROUND

### Technical Field

The present invention relates to wireless communication in millimeter wave frequency bands and, more particularly, to beam alignment for millimeter wave systems in the presence of multi-path.

### Description of the Related Art

Millimeter wave (mmWave) frequency bands provide abundant spectrum which can be utilized to provide multi Gbps throughputs in wireless systems. However, there are a number of obstacles such as high path loss, severe shadowing, and intense blockage in realizing such speeds in practical mmWave systems. On the other hand, due to the small wavelength in mmWave frequencies, it is feasible to employ massive antenna arrays at the transceivers and use beamforming (BF) techniques to create directional transmission and reception patterns (narrow beams) and focus the energy toward the direction of interest so as to compensate for the impact of path loss and shadowing.

### SUMMARY

A method for implementing a multi-user beam alignment (BA) scheme in a multi-path environment of a single-cell millimeter wave (mmWave) network is presented. The method includes enabling a base station to communicate with a plurality mobile devices handled by a plurality of users within the single-cell mmWave network, estimating an angle of departure (AoD) for the plurality of users within a discrete set of intervals, transmitting, via the base station, scanning beams (SBs) to receive feedback messages from the plurality of users, the feedback messages determining if an AoD associated with a resolvable path of the user belongs to an angular coverage region (ACR) of a given beam, transmitting, via the base station, data transmission beams (DTBs) as a function of the feedback messages and the SBs, and applying a spatial diversity policy and a beamforming policy based on the feedback messages to consider constraints on contiguity of the SBs and the DTBs.

A non-transitory computer-readable storage medium comprising a computer-readable program for implementing a multi-user beam alignment (BA) scheme in a multi-path environment of a single-cell millimeter wave (mmWave) network is presented. The computer-readable program when executed on a computer causes the computer to perform the steps of enabling a base station to communicate with a plurality mobile devices handled by a plurality of users within the single-cell mmWave network, estimating an angle of departure (AoD) for the plurality of users within a discrete set of intervals, transmitting, via the base station, scanning beams (SBs) to receive feedback messages from the plurality of users, the feedback messages determining if an AoD associated with a resolvable path of the user belongs to an angular coverage region (ACR) of a given beam, transmitting, via the base station, data transmission beams (DTBs) as a function of the feedback messages and the SBs, and applying a spatial diversity policy and a beamforming policy based on the feedback messages to consider constraints on contiguity of the SBs and the DTBs.

A system for implementing a multi-user beam alignment (BA) scheme in a multi-path environment of a single-cell millimeter wave (mmWave) network is presented. The system includes a memory and one or more processors in communication with the memory configured to enable a base station to communicate with a plurality mobile devices handled by a plurality of users within the single-cell mmWave network, estimate an angle of departure (AoD) for the plurality of users within a discrete set of intervals, transmit, via the base station, scanning beams (SBs) to receive feedback messages from the plurality of users, the feedback messages determining if an AoD associated with a resolvable path of the user belongs to an angular coverage region (ACR) of a given beam, transmit, via the base station, data transmission beams (DTBs) as a function of the feedback messages and the SBs, and apply a spatial diversity policy and a beamforming policy based on the feedback messages to consider constraints on contiguity of the SBs and the DTBs.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary time slotted system, in accordance with embodiments of the present invention;

FIG. 2 is a block/flow diagram of exemplary beamforming solutions obtained by using different policies, in accordance with embodiments of the present invention;

FIG. 3 is a block/flow diagram illustrating a single-cell millimeter wave (mmWave) network with a single base station and a plurality of users handing a plurality of mobile devices, in accordance with embodiments of the present invention;

FIG. 4 is a block/flow diagram illustrating beam alignment to align narrow beams with an angle of departure (AoD) of channel clusters, in accordance with embodiments of the present invention;

FIG. 5 is an exemplary practical application for implementing a multi-user beam alignment (BA) scheme in a multi-path environment of a single-cell millimeter wave (mmWave) network, in accordance with embodiments of the present invention;

FIG. 6 is an exemplary processing system for implementing a multi-user beam alignment (BA) scheme in a multi-path environment of a single-cell millimeter wave (mmWave) network, in accordance with embodiments of the present invention; and

FIG. 7 is a block/flow diagram of an exemplary method for implementing a multi-user beam alignment (BA) scheme in a multi-path environment of a single-cell millimeter wave (mmWave) network, in accordance with embodiments of the present invention.

### DETAILED DESCRIPTION OF PREFERRED EMBODIMENTS

In order to utilize beamforming (BF) gain, it is important to create the narrow beams aligned with the angle of departure (AoD) of the spatial clusters of the mmWave channels. As a result, a wide range of beam alignment (BA), that is, beam search algorithms with various objectives have been proposed. Exhaustive search (ES) and hierarchical search (HS) strategies are among the conventional algorithms used for BA in the wireless standards. However, experimental studies have demonstrated that mmWave channels incorporate a few spatial clusters. Current systems and methods on mmWave beamforming have not properly addressed multipath propagation, and instead focus on a single dominant path.

BA schemes are classified into two categories, non-interactive BA (NI-BA), and interactive BA (I-BA) methods. In NI-BA, the scanning phase occurs first by the transmitter and the receiver's feedback is sent after performing all the scans. ES is an example of NI-BA where various directions are scanned through a set of beams and the beam with the highest received power is chosen. In I-BA, on the other hand, part of the feedback messages is received during the scanning phase which is used in the subsequent scans by the transmitter. An example of I-BA is HS where the algorithms search wider sectors first using coarser beams, and then refine the search based on the receiver feedback. While I-BA can potentially lead to better performance compared to NI-BA, most of the conventional optimized I-BA algorithms are single user in nature since the feedback from the users are potentially different. As a result, I-BA is not straightforward to generalize for multiple users. Nevertheless, practical scenarios include multiple users in which using optimized multi-user BA strategies leads to lesser delay and overhead, as beam management is performed simultaneously for multiple users. Additionally, optimizing NI-BA is more tractable in multi-user scenarios as the scanning and feedback phases are independent.

Most of the prior analytical studies on mmWave BA have considered a single dominant path for the underlying mmWave channel to reduce the complexity of the analysis. In these studies, the objective is to exploit the BF gain and achieve various goals such as maximizing the throughput or minimizing the power consumption. However, experimental studies have shown the possibility of having several comparable paths in indoor and outdoor scenarios which can be used to achieve spatial diversity (SD) gains. More importantly, blockage in mmWave system is a serious issue. When a direct path between the transmitter and receiver is blocked, the use of a secondary beam is important to maintain the connection. Hence, it is beneficial to exploit the existence of secondary paths in the design of BA strategies to combat blockage. While having a multi-path channel model in BA design can increase the analysis complexity, addressing blockage and exploiting diversity to increase reliability cannot be ignored in mmWave systems.

The exemplary embodiments introduce multi-user NI-BA in a multi-path mmWave environment and provide an analytical framework to design and analyze optimized BA schemes. The optimal multi-user NI-BA has been derived with the assumption of a single dominant path. The exemplary BA schemes of the exemplary embodiments not only provide BF gains to compensate for the impact of path loss and shadowing, but also enable diversity gains to cope with the blockage.

Thus, the exemplary embodiments address the issue of multi-user NI-BA in multi-path mmWave environments. By considering multi-path, the exemplary methods provide a solution to mitigate the blockage which is an inevitable issue in mmWave systems and exploit diversity to increase the reliability of the system, e.g., by means of encoding through multiple parallel spatial channels. The exemplary methods provide a framework to design and optimize multi-user NI-BA which incorporates modeling the prior knowledge on the users' AoDs, consider different policies based on the users' feedback, and consider possible constraints on the contiguity of the scanning beams (SBs) and data transmission beams (DTBs).

The exemplary methods further introduce two different policies for BA, namely spatial diversity (SD) policy and beamforming (BF) policy. The SD policy aims to minimize the angular span of the DTBs while covering all possible directions that may include a resolvable channel cluster. On the other hand, the BF policy aims to increase the beamforming gain by further reducing the angular span of the DTB to cover at least one resolvable path (but not necessarily all the resolvable paths).

The exemplary methods consider the downlink of a single-cell mmWave scenario with one base station (BS) and an arbitrary number of users (UEs), say N users. The number of the users may or may not be known. The goal of BA scheme is to find the direction of beams (corresponding to AoD of the user channel from the BS) to serve the users. In the BA scheme, the BS sends probing (scanning) packets using different beams and receives feedback from each user in regards to the probing packets. Then the BS computes a beam for each user based on the received feedback.

For simplicity, the exemplary methods consider a two-dimensional space corresponding to the location of the users in the azimuth plane around the BS. However, the results can be generalized for three-dimensional space by incorporating the elevations as well. The exemplary methods consider multi-path in a wireless channel between the BS and UEs in the beam alignment which is one of the major differences with conventional systems. The exemplary methods assume that the mmWave propagation channel between the BS and the users includes a maximum of p paths (spatial clusters). In a robust design, the number of paths p may be unknown or p may only represent an upper bound on such number of significant paths.

Regarding the channel model, let Ψⱼ, j∈[N] denote the vector of random AoDs corresponding to the spatial clusters in the channel from the BS to the jth user, where Ψⱼ, =[ψ₁ⱼ, ψ₂ⱼ . . . ], and ψ₁ⱼ is the AoD of the ith path. The exemplary methods assume that the channels are stationary in the time interval of interest. The exemplary methods consider an arbitrary probability distribution function (PDF) f_{Ψj}(ψ₁ⱼ, . . . , ψₚⱼ) for Ψⱼ over D [symbol] [symbol] (0, 2π]^{p} for user channels with maximum p resolvable paths, which are paths with enough power to be useful for communication or at least detectable. This distribution reflects the prior knowledge about the AoD, which for example could correspond to the previously localized AoD in beam tracking applications. The correlation between the user paths may also be modeled in the distribution. On the other hand, this distribution may be enforced even where no prior knowledge about the user paths is known to perform a scheduled search over different AoD angles, in which case the enforced probability distribution may be interpreted as the priority function in the search space.

It is noted that resolvable paths are usually limited in numbers, particularly in mmWave bands. The power profile of such resolvable paths across the azimuth and elevation angle depends on the environment, nonetheless, it is usually possible to assume that the set of resolvable paths follow a power profile where there is a considerable (at least 3 dB or more) power difference between each pair of paths. Therefore, resolvable paths are the paths between a transmitter and a receiver that may not become undetectable due to superposition. However, the superposition of the signals received through multiple such resolvable paths may experience fluctuations in power.

Regarding beamforming (BF), the exemplary methods assume that the BS has a large antenna array as envisioned for mmWave communications which allows a particular beam resolution to be achieved while the user has an omnidirectional transmission and reception pattern for the BA phase. Furthermore, the exemplary methods consider a single RF chain along with analog BF at the BS due to practical considerations such as power consumption. To model the directionality of the BS transmission due to the BF, the exemplary methods adopt a sectored antenna model, characterized by two parameters, that is, a constant main lobe gain and the angular coverage region (ACR) which is the union of the angular interval(s) covered by the main-lobe. The exemplary methods neglect the effect of the side-lobes. While this ideal model is considered for theoretical tractability, modifications may be applied to generalize the antenna model for practical scenarios where the beam pattern roll-off is not sharp.

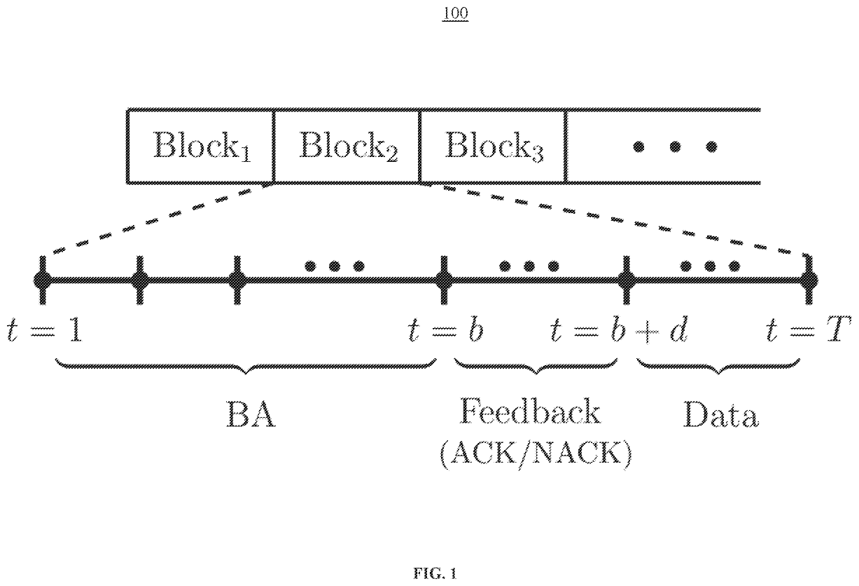

Regarding frames and feedback, the exemplary methods consider a time division duplex (TDD) protocol 100, in which a frame is divided into blocks of T time slots as depicted in FIG. 1. The exemplary methods consider the NI-BA scenario where b time slots (called scanning time slots (STS) or probing time slots (PTS)) are used to scan the angular space. The benefits of using the NI-BA scheme is that it can be used to simultaneously probe multiple users. Hence, the feedback for the users is received over d time slots (called the feedback time slots (FTS)). These d slots are allocated for the users' feedback where an individual feedback slot may be scheduled for a particular user or set of users, say based on their ID, or it might be freely used by any user in a random access mode. Finally, the rest of the T−b−d slots in each frame are data transmission slots (DTS). Alternatively, the feedback from the users may be received through a side channel.

Regarding scanning beams and data transmission beams, the exemplary methods consider a BA scheme phase in order to estimate the users' AoDs such that narrower beams (which are translated to higher BF gains) can be used to serve the users during a data communication phase. The localization or estimation of the user AoDs is within a discrete set of intervals which in turn are based on the set of beams that are used on STS. At each time slot t∈[b] during the STS in the BA phase, the BS transmits a probing packet using a beam with a single ACR Φᵢ to scan that angular region while the users are silent. The beam J is called a scanning beam (SB) and the set [symbol] ={Φᵢ}ᵢ₌₁^{b} is the set of the scanning beams. The feedback message from the users includes the indication of the beams whose corresponding probing packets are received by the user. Therefore, this feedback message can determine if an AoD associated with a resolvable path of the user belongs to the ACR of a given beam in which case it is considered as an acknowledgment (ACK). The feedback can also determine if no AoD for any resolvable path of the user belongs to the ACR for a given beam which is considered a negative acknowledgement (NACK).

The BS then chooses a data transmission beam (DTB) for transmission in DTS as a function of the received feedback and the set of SB s. This function captures different BA strategies and hence is referred to as policy. Formally, a policy is defined as a function from the set of feedback sequences onto the set of DTB. Although SB s have a single ACR due to the importance of having beams with very sharp edges, the DTBs may include a composite beam that covers a few disjoint ACRs.

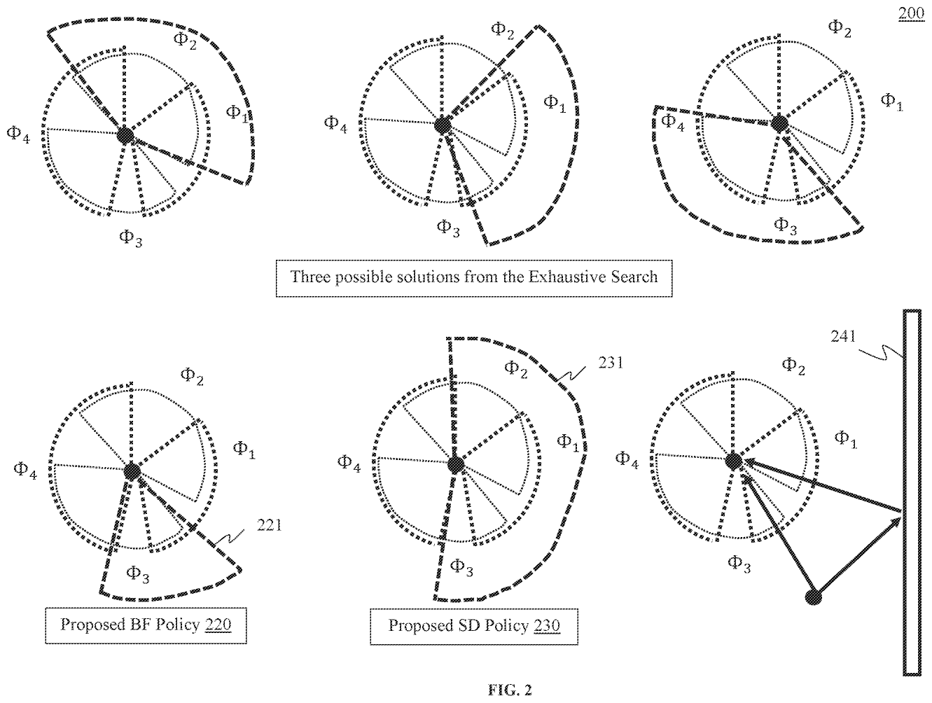

Regarding policy, based on the feedback, the BS calculates the beam to be used for a user. The policy defines how the beam calculation is performed. A natural policy is to direct the beam in the angles which correspond to the uncertainty region (UR) of possible AoD of the user channel. Two policies are defined, that is, an SD policy 230 and a BF policy 220, as shown in FIG. 2, which illustrates beamforming solutions 200 obtained by different polices. SD policy 230 aims to minimize the angular span of the DTB while covering all possible angles that may include a resolvable path. On the other hand, BF policy 220 aims to increase the beamforming gain by further reducing the angular span of the DTB to cover at least one resolvable path (but not necessarily all the resolvable paths). It is noted that a policy may also be a function of other feedback signals received from the user such as the signal strength or indication of the channel qualities for different beams.

The SD policy 230 is beneficial to maintain the connection if one or some of the paths are blocked if at least one of the paths is still resolvable and it is not blocked. However, the DTB in SD policy generally has a larger angular span and hence is lesser in the beamforming gain it provides. The BF policy 220, on the other hand, usually provides much higher BF gain but it may suffer from blockage. Hence, both policies 220, 230 have important properties and may be useful in different scenarios to tradeoff between the connectivity and beamforming gain.

For SD policy 230, the exemplary methods define B_{SD}(s) as the UR of AoD of user j with feedback sequence s, which is the minimum angular span (possibly non-contiguous) that includes all resolvable paths of the user j. For the BF policy 220, the exemplary methods consider a notion of minimal UR that includes at least one resolvable path (denoted by B_{BF}(s)) instead of the minimal UR, which includes all resolvable paths (e.g., B_{SD}(s)). In the following, B_{SD}(s) and B_{BF}(s) are first derived, where the knowledge regarding the maximum number of paths is not available. It is noted that B_{SD}(s) and B_{BF}(s) are also functions of the scanning beam set and they are defined to be empty for a user that is not registered in a frame, which means that BS has not received any ACK from that user.

Regarding the multipath, considering multipath channels, e.g., where the user channel has multiple resolvable paths (e.g., 2 or more path), the positive feedback (ACK) for the beam Φᵢ means that it has at least one resolvable path, hence B_{SD}(s)∩Φᵢ has at least one resolvable path. A possible path for a user is defined if the user is registered in a frame which means that it has received at least one ACK from that user. On the other hand, a negative feedback (NACK) for the beam Φᵢ means that Φᵢ includes no resolvable path, which means that B_{SD}(s)∩Φᵢ has no resolvable path. This means that B_{SD}(s)∈ [symbol] −Φᵢ, where [symbol] [symbol] [0, 2π) is the initial uncertainty of the user AoD.

Therefore, for the UR for the user j:

B_{SD}(s)=(∪_{i∈S}_{_{A}}₍ₛ₎θᵢ(s))∩(∩_{i∈S}_{_{N}}₍ₛ₎θᵢ(s))

where s is the received feedback sequence and Θᵢ(s)=Φᵢ if ACK is received for the SB i, e.g., if the bit i of s is set, and Θᵢ(s)= [symbol] −Φᵢ, otherwise (NACK). The set of {Θᵢ(s)}ᵢ₌₁^{b} can be found based on the feedback sequence. For a feedback sequence s, let S_{A}(s) and S_{N}(s) denote the indices of the beams for which an ACK and NACK is received, respectively.

As mentioned earlier, it is sometimes useful to consider a notion of minimal UR that includes at least one resolvable path (but not necessarily all paths) denoted by B_{BF}(s). Since a positive feedback (ACK) for the beam Φₖ means that it has at least one resolvable path and a negative feedback (NACK) for the beam Φi means that Φi includes no resolvable path, the beam Θₖ(s)∩(U_{i∈S}_{_{N}}₍ₛ₎Θᵢ(s)) still includes one resolvable path.

Hence, it is enough to find the index of k which results in the beam with smallest angular span, as follows:

$$\begin{matrix}{B}_{BF} ( s ) = {Θ}_{k} ( s ) ⋂ ( {⋃}_{i ∈ {S}_{N} ( s )} {Θ}_{i} ( s ) ) , \\ k = {arg min}_{j ∈ {S}_{A} ( s )} \vert {Θ}_{j} ( s ) ) ⋂ ( {⋃}_{i ∈ {S}_{N} ( s )} {Θ}_{i} ( s ) ) \vert\end{matrix}$$

where |Φ| denotes the angular span or size of the beam Φ and s is the received feedback sequence.

The expressions for both BF policy and SD policy are derived for multipath where the knowledge of the number of the resolvable paths is not available. It is noted that either of B_{SD}(s) or B_{BF}(s) may be applied to other scenarios where the number of paths is known, however, in such cases the policy is not necessarily calculated by the optimal UR.

It is noted that the set of DTBs [symbol] ={uᵢ}ₖ₌₁^{M} is defined as the set of all possible values of BSD(s) in B_{SD}(s) for the SD policy or BBF(s) in B_{BF}(s) for BF policy. The set of DTBs [symbol] in general is not a partitioning of the search domain [symbol] . However, in the following it is considered a special case of the channel model with only a single path (could be interpreted as single dominant path) where both SD and BF policies coincide and become the same, and the set of DTBs [symbol] partitions the domain [symbol] .

FIG. 2 illustrates a user whose signal is received at the base station in two paths, that is, a direct path and a path with a single reflection off a wall 241. Assuming that four probing beams Φᵢ, i=1, . . . , 4 are used as depicted, the coverage intervals of the resulting beamformer for different policies are illustrated with dashed dark black lines 221, 231. An exhaustive search algorithm would receive a positive feedback for all three beams Φᵢ, i=1, . . . , 3, and hence would pick one of such beams illustrated by the top three illustrations in FIG. 2. However, the SD policy 230 would pick an angular coverage region that incorporates the union of the angular coverage region of the first three beams Φᵢ, i=1, . . . , 3 but not that of the beam 14. The BF policy 220, on the other hand, finds the smallest interval that includes at least one path of the user. FIG. 2 illustrates the angular coverage interval for the BF and SD policy 220, 230. It is observed that while exhaustive search provides a solution that includes at least one path for the user, it does not have the best beamforming gain while the BF solution 220 provides sharper beam and hence better beamforming gain. On the other hand, the exhaustive search solution is not guaranteed to cover all the paths of the user, either. However, the SD solution 230 provides a beam with the smallest angular coverage interval which covers all the paths of the user.

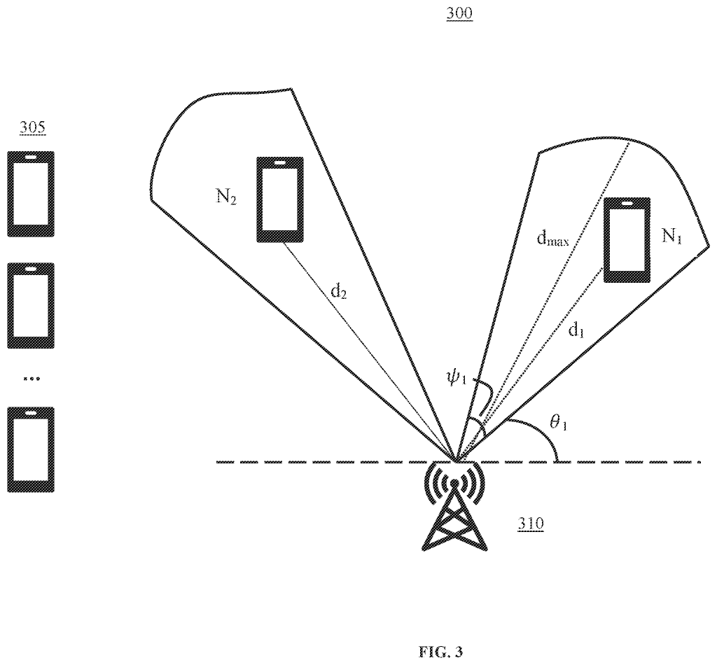

FIG. 3 is a block/flow diagram illustrating a single-cell millimeter wave (mmWave) network with a single base station and a plurality of users handing a plurality of mobile devices, in accordance with embodiments of the present invention.

The single-cell millimeter wave (mmWave) network 300 includes a base station 310 and mobile devices 305 handled by a plurality of users N. The base station 310 is located at the origin and the mobile devices or users are located at an angular coordinate θ₁ and at distance di from the base station 310. dₘₐₓ>0 is a coverage area of the base station 310 and ψ₁ denotes the vector of random AoDs corresponding to the spatial clusters in the channel from the base station 310.

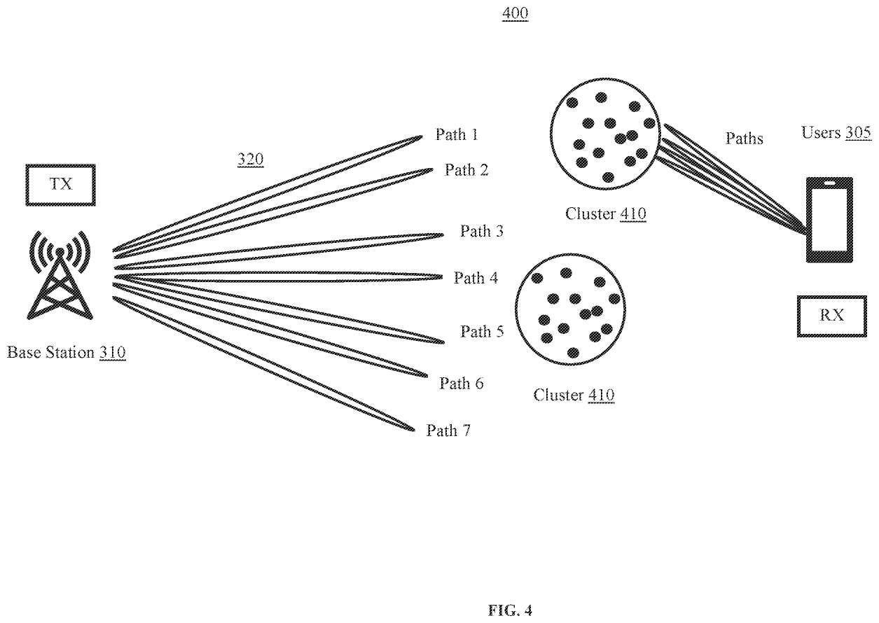

FIG. 4 is a block/flow diagram 400 illustrating beam alignment to align narrow beams with an angle of departure (AoD) of channel clusters, in accordance with embodiments of the present invention.

The transmitter or base station 310 transmits narrow beams 320 to a cluster 410. The model 400 considers a cluster 410 of scatterers, where the cluster is resolvable to several paths, e.g., 7 paths in the instant example. The receiver or mobile device 305 scans the 2D angular space to communicate with the cluster 410.

The effect of scattering heavily influences mmWave channel modeling based upon ray tracing concepts. Clusters or sources of reflection and scattering are defined as alternative sources of energy. Scattering sub-events are integral part of such channels, and they can be modeled around various representative patterns with the intent of deriving coefficients to capture the effect of the rough surface area of a scattering cross section and the impact of the ensuing power dispersion.

In summary, millimeter wave (mmWave) communication systems have attracted significant interest regarding meeting the capacity requirements of the future 5G network. The mmWave systems have frequency ranges in between 30 and 300 GHz where a total of around 250 GHz bandwidths are available. Although the available bandwidth of mmWave frequencies is promising, the propagation characteristics are significantly different from microwave frequency bands in terms of path loss, diffraction and blockage, rain attenuation, atmospheric absorption, and foliage loss behaviors. In general, the overall loss of mmWave systems is significantly larger than that of microwave systems for a point-to-point link. Fortunately, however, the small wavelengths of mmWave frequencies enable large numbers of antenna elements to be deployed in the same form factor thereby providing high spatial processing gains that can theoretically compensate for at least the isotropic path loss. Nevertheless, as mmWave systems are equipped with several antennas, a number of computation and implementation challenges arise to maintain the anticipated performance gain of mmWave systems.

Directional transmission patterns (narrow beams) are the key to wireless communications in millimeter wave (mmWave) frequency bands which suffer from high path loss, severe shadowing, and intense blockage. In addition, the propagation channel in mmWave frequencies incorporates only a few number of spatial clusters requiring a procedure, referred to as beam alignment (BA), to align the corresponding narrow beams with the angle of departure (AoD) of the channel clusters. In addition, BA enables beamforming gains to compensate path loss and shadowing or diversity gains to combat the blockage. Most of the prior analytical studies have considered strong simplifying assumptions such as having a single-user scenario and having a single dominant path channel model for theoretical tractability.

Toward this end, the exemplary embodiments provide a theoretical framework to design and analyze optimized multi-user BA schemes in multi-path environments. Such BA schemes not only reduce the BA overhead and provide beamforming gains to compensate path loss and shadowing, but also provide diversity gains to mitigate the impact of blockage in practical mmWave systems.

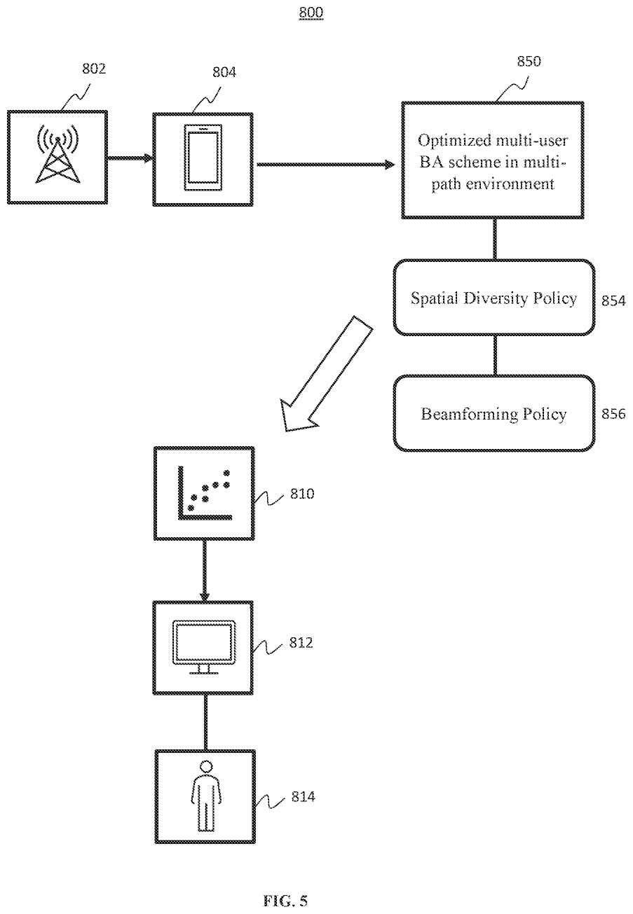

FIG. 5 is a block/flow diagram 800 of a practical application for implementing a multi-user beam alignment (BA) scheme in a multi-path environment of a single-cell millimeter wave (mmWave) network, in accordance with embodiments of the present invention.

In one practical example, a transmitter 802 is in communication with a receiver 804, and an optimized multi-user BA scheme 850 is implemented in a multi-path environment via a spatial diversity policy 854 and a beamforming policy 856. The results 810 (e.g., variables or parameters or factors or communications or beam alignment acknowledgments) can be provided or displayed on a user interface 812 handled by a user 814.

Regarding the practical applications of the exemplary embodiments, the novelty of 5G is the integration of multiple networks serving diverse sectors, domains and applications, such as multimedia, virtual reality (VR) and augmented reality (AR), machine to machine (M2M) and internet of things (IoT), automotive applications, smart city, etc. The diversity of the 5G applications and their related service requirements in terms of data rate, latency, reliability, and other parameters leads to the necessity for operators to provide a diverse set of 5G networks.

Among the various innovations enabling 5G, one of main necessities and realities is the use of mmWave spectrum be coupled with network densification and massive multiple input, multiple output (MIMO) to serve as an ultra-high-speed access and backhaul systems. A key ingredient for 5G is to enable applications in the mmWave spectrum, such as mobile edge computing (MEC), which is expected to bring information and processing closer to the mobile users and enable ultra-high speed and low latency communications. The exemplary embodiments of the present invention can allow such applications to be successfully implemented.

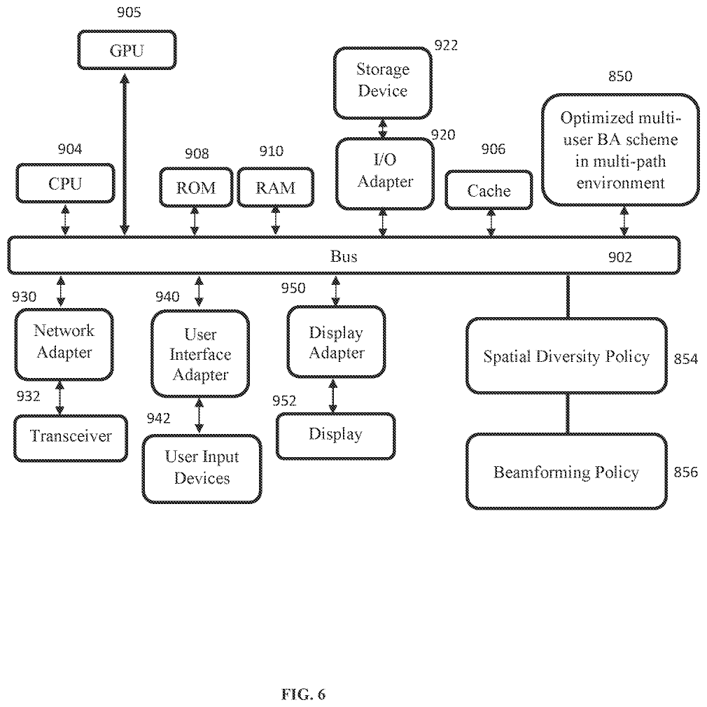

FIG. 6 is an exemplary processing system for implementing a multi-user beam alignment (BA) scheme in a multi-path environment of a single-cell millimeter wave (mmWave) network, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, a transmitter 802 is in communication with a receiver 804, and an optimized multi-user BA scheme 850 is implemented in a multi-path environment via a spatial diversity policy 854 and a beamforming policy 856.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

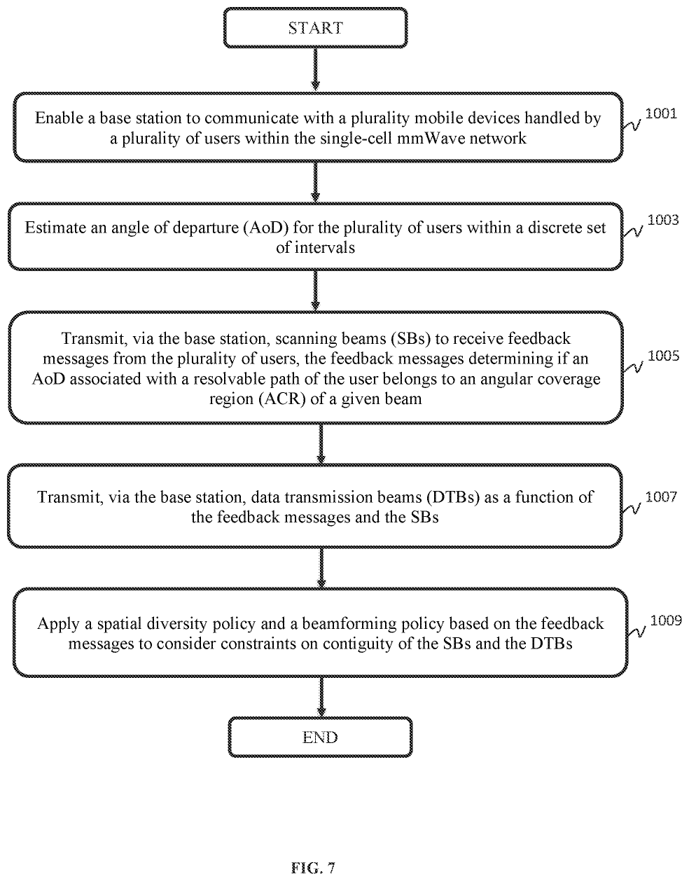

FIG. 7 is a block/flow diagram of an exemplary method for implementing a multi-user beam alignment (BA) scheme in a multi-path environment of a single-cell millimeter wave (mmWave) network, in accordance with embodiments of the present invention.

At block 1001, enabling a base station to communicate with a plurality mobile devices handled by a plurality of users within the single-cell mmWave network.

At block 1003, estimating an angle of departure (AoD) for the plurality of users within a discrete set of intervals.

At block 1005, transmitting, via the base station, scanning beams (SBs) to receive feedback messages from the plurality of users, the feedback messages determining if an AoD associated with a resolvable path of the user belongs to an angular coverage region (ACR) of a given beam.

At block 1007, transmitting, via the base station, data transmission beams (DTBs) as a function of the feedback messages and the SBs.

At block 1009, applying a spatial diversity policy and a beamforming policy based on the feedback messages to consider constraints on contiguity of the SBs and the DTBs.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for implementing a multi-user beam alignment (BA) scheme in a multi-path environment of a single-cell millimeter wave (mmWave) network, the method comprising:
enabling a base station to communicate with a plurality mobile devices handled by a plurality of users within the single-cell mmWave network;
estimating an angle of departure (AoD) for the plurality of users within a discrete set of intervals;
transmitting, via the base station, scanning beams (SBs) to receive feedback messages from the plurality of users, the feedback messages determining if an AoD associated with a resolvable path of the user belongs to an angular coverage region (ACR) of a given beam;
transmitting, via the base station, data transmission beams (DTBs) as a function of the feedback messages and the SBs; and
applying a spatial diversity policy and a beamforming policy based on the feedback messages to consider constraints on contiguity of the SBs and the DTBs.

2. The method of claim 1, wherein a time division duplex (TDD) protocol is employed to divide a frame into blocks of multiple time slots to scan an angular space.

3. The method of claim 2, wherein the multiple time slots include scanning time slots (STS), feedback time slots (FTS), and data transmission time slots (DTS).

4. The method of claim 1, wherein the spatial diversity policy minimizes an angular span of the DTBs while covering all directions that include a resolvable channel cluster.

5. The method of claim 4, wherein the beamforming policy maximizes a beamforming gain by further reducing the angular span of the DTBs to cover at least one resolvable path.

6. The method of claim 1, wherein, if the AoD is associated with the resolvable path, a positive acknowledgment is generated to indicate at least one resolvable path.

7. The method of claim 1, wherein, if the AoD is not associated with the resolvable path, a negative acknowledgment is generated to indicate no resolvable path.

8. A non-transitory computer-readable storage medium comprising a computer-readable program for implementing a multi-user beam alignment (BA) scheme in a multi-path environment of a single-cell millimeter wave (mmWave) network, wherein the computer-readable program when executed on a computer causes the computer to perform the steps of:
enabling a base station to communicate with a plurality mobile devices handled by a plurality of users within the single-cell mmWave network;
estimating an angle of departure (AoD) for the plurality of users within a discrete set of intervals;
transmitting, via the base station, scanning beams (SBs) to receive feedback messages from the plurality of users, the feedback messages determining if an AoD associated with a resolvable path of the user belongs to an angular coverage region (ACR) of a given beam;
transmitting, via the base station, data transmission beams (DTBs) as a function of the feedback messages and the SBs; and
applying a spatial diversity policy and a beamforming policy based on the feedback messages to consider constraints on contiguity of the SBs and the DTBs.

9. The non-transitory computer-readable storage medium of claim 8, wherein a time division duplex (TDD) protocol is employed to divide a frame into blocks of multiple time slots to scan an angular space.

10. The non-transitory computer-readable storage medium of claim 9, wherein the multiple time slots include scanning time slots (STS), feedback time slots (FTS), and data transmission time slots (DTS).

11. The non-transitory computer-readable storage medium of claim 8, wherein the spatial diversity policy minimizes an angular span of the DTBs while covering all directions that include a resolvable channel cluster.

12. The non-transitory computer-readable storage medium of claim 11, wherein the beamforming policy maximizes a beamforming gain by further reducing the angular span of the DTBs to cover at least one resolvable path.

13. The non-transitory computer-readable storage medium of claim 8, wherein, if the AoD is associated with the resolvable path, a positive acknowledgment is generated to indicate at least one resolvable path.

14. The non-transitory computer-readable storage medium of claim 8, wherein, if the AoD is not associated with the resolvable path, a negative acknowledgment is generated to indicate no resolvable path.

15. A system for implementing a multi-user beam alignment (BA) scheme in a multi-path environment of a single-cell millimeter wave (mmWave) network, the system comprising:
a memory; and
one or more processors in communication with the memory configured to:
enable a base station to communicate with a plurality mobile devices handled by a plurality of users within the single-cell mmWave network;
estimate an angle of departure (AoD) for the plurality of users within a discrete set of intervals;
transmit, via the base station, scanning beams (SBs) to receive feedback messages from the plurality of users, the feedback messages determining if an AoD associated with a resolvable path of the user belongs to an angular coverage region (ACR) of a given beam;
transmit, via the base station, data transmission beams (DTBs) as a function of the feedback messages and the SBs; and
apply a spatial diversity policy and a beamforming policy based on the feedback messages to consider constraints on contiguity of the SBs and the DTBs.

16. The system of claim 15, wherein a time division duplex (TDD) protocol is employed to divide a frame into blocks of multiple time slots to scan an angular space.

17. The system of claim 16, wherein the multiple time slots include scanning time slots (STS), feedback time slots (FTS), and data transmission time slots (DTS).

18. The system of claim 15, wherein the spatial diversity policy minimizes an angular span of the DTBs while covering all directions that include a resolvable channel cluster.

19. The system of claim 18, wherein the beamforming policy maximizes a beamforming gain by further reducing the angular span of the DTBs to cover at least one resolvable path.

20. The system of claim 15,
wherein, if the AoD is associated with the resolvable path, a positive acknowledgment is generated to indicate at least one resolvable path; and
wherein, if the AoD is not associated with the resolvable path, a negative acknowledgment is generated to indicate no resolvable path.
